(19) United States
(12) Patent Application Publication
(10) Pub. No.: US 2011/0307146 A1
(43) Pub. Date: Dec. 15, 2011

(54) SAFETY DETECTION APPARATUS FOR EXITING A VEHICLE

(75) Inventors: Hua Yang, Shanghai (CN); Ran Li, Shanghai (CN)

(73) Assignee: DELPHI TECHNOLOGIES, INC., Troy, MI (US)

(21) Appl. No.: 13/202,823

(22) PCT Filed: Mar. 24, 2010
(86) PCT No.: PCT/US2010/028390

§ 371 Date: Aug. 23, 2011

(30) Foreign Application Priority Data
Mar. 30, 2009 (CN) 200920008221.8

(51) Int. Cl. G06F 7/00

(52) U.S. Cl. 701/36; 701/1

(57) ABSTRACT

A safety detection apparatus for exiting a vehicle is disclosed, according to an embodiment, the safety detection apparatus utilizes a circumstance detecting means such as an infrared detector, a radar detector, or a video monitor to detect a moving object signal. A parameter determining means generates a relative position signal and a relative velocity signal of the moving object to the vehicle based on the moving object signal detected by the circumstance detecting means. A safety analyzing means obtains the relative position signal and the relative velocity signal of the moving object from the parameter determining means and generates an exiting safety level signal, the exiting safety level signal is determined based on the relative position signal and the relative velocity signal of the moving object, a distance threshold, and a velocity threshold. A safety controlling means obtains the exiting safety level signal from the safety analyzing means and outputs a control instruction corresponding to the exiting safety level.

### CROSS REFERENCE TO RELATED APPLICATIONS

This application claims the benefit under 35 U.S.C. §371 of PCT Patent Application Number PCT/US2010/28390, filed Mar. 24, 2010, and China Utility Application No. 200920008221.8, filed Mar. 30, 2009, the entire disclosure of which is hereby incorporated herein by reference.

### FIELD OF THE INVENTION

Embodiments of the present application relate to the field of automobile parts, more particularly, relate to a safety detection apparatus for passengers exiting a vehicle.

### BACKGROUND

A passenger is hit by a car from behind with high velocity when the passenger exits a vehicle, or, when a passenger opens a door of a vehicle, the door hits a bicycle or motorcycle from behind. Such accidents often happen. When a vehicle is parked next to a curb and a passenger exits the vehicle, it would be a high possibility that such accidents may occur. Though the accidents may be avoided by a careful observation before exiting the vehicle, most passengers may forget to observe before exit. Especially, when the passenger is a child or an old person, or in an emergency, the passenger will open the door and exit the vehicle without the observation. The condition mentioned above is very dangerous and shall be avoided as far as possible. It would be desirable that a particular apparatus be provided to assist the observation before exit.

### SUMMARY

Embodiments of the present application provide a safety detection apparatus for passengers exiting a vehicle. The apparatus observes the circumstance before the passengers exit the vehicle, performs an exiting safety determination and takes a corresponding action.

According to an embodiment, a safety detection apparatus for exiting a vehicle utilizes a circumstance detecting means such as an infrared detector, a radar detector, or a video monitor to detect a moving object signal. A parameter determining means generates a relative position signal and a relative velocity signal of the moving object to the vehicle based on the moving object signal detected by the circumstance detecting means. A safety analyzing means obtains the relative position signal and the relative velocity signal of the moving object from the parameter determining means and generates an exiting safety level signal, the exiting safety level signal is determined based on the relative position signal and the relative velocity signal of the moving object, a distance threshold, and a velocity threshold. A safety controlling means obtains the exiting safety level signal from the safety analyzing means and outputs a control instruction corresponding to the exiting safety level.

According to an embodiment, the control instruction outputted by the safety controlling means includes a locking instruction to lock the door of the vehicle under a high danger level, a control instruction to control lights inside and outside the vehicle under a medium danger level, and no instruction under low danger level.

According to an embodiment, the apparatus is automatically enabled when the velocity detector detects that the velocity of the vehicle is lower that a predetermined value.

The safety detection apparatus may observe the circumstance around the vehicle before a passenger exits the vehicle, the safety detection apparatus determines a safety level and take appropriate actions to as to reduce the possibility of accident.

### BRIEF DESCRIPTION OF THE DRAWINGS

The above or other features, natures or advantages of the present disclosure will be more obvious to the skilled person in the art by the following descriptions of the embodiments accompanying with the drawings, the same sign reference indicates the identical features throughout the description, and wherein:

FIG. 1 illustrates a structural diagram of a safety detection apparatus for passengers exiting a vehicle according to an embodiment of the present disclosure.

FIG. 2 illustrates a structural diagram of a safety analyzing means according to an embodiment of the present disclosure.

FIG. 3a and FIG. 3b illustrates the logic of categorizing the exiting safety levels according to an embodiment of the present disclosure.

### DETAILED DESCRIPTION

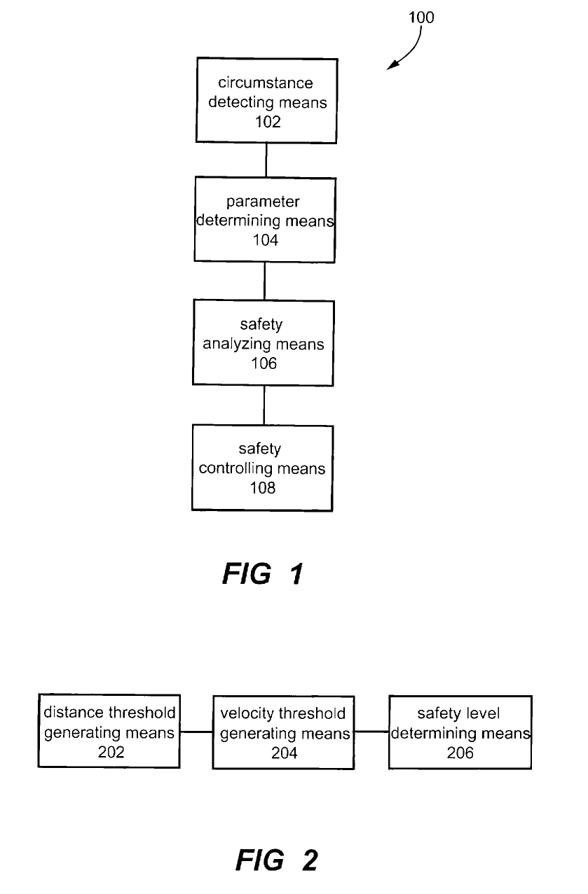

A safety detection apparatus 100 for passengers exiting a vehicle according to an embodiment is illustrated in FIG. 1. The safety detection apparatus 100 includes a circumstance detecting means 102, a parameter determining means 104, a safety analyzing means 106 and a safety controlling means 108.

The circumstance detecting means 102 is configured to detect information about a moving object is adjacent the vehicle and generate a moving object signal. Position information and velocity information about a moving object approaching the vehicle from behind is mostly concerned. The circumstance detecting means 102 may be implemented in various ways, such as an infrared detector, a radar detector, or a video monitor, which are all mature techniques and are widely used. Position information, velocity information and moving orientation information about a moving object around the vehicle, especially behind the vehicle may be obtained by the circumstance detecting means 102. The circumstance detecting means 102 will generate signal representative of such information.

The parameter determining means 104 is configured to determine a relative position signal and a relative velocity signal of the moving object to the vehicle, for analysis of an exiting safety level. The parameter determining means 104 determines the relative position signal and the relative velocity signal of the moving object to the vehicle based on the signals obtained by the circumstance detecting means 102 and generate a relative position signal and a relative velocity signal of the moving object to the vehicle. A distance value is used to represent the relative position and a speed value is used to represent the relative velocity.

The safety analyzing means 106 is used to determine an exiting safety level. The exiting safety level is determined based on the relative position and the relative velocity of the moving signal to the vehicle, a predetermined distance threshold and a predetermined velocity threshold. As shown in FIG. 2, according to an embodiment, the safety analyzing means 106 may include a distance threshold generating means 202, a velocity threshold generating means 204 and a safety level determining means 206. The distance threshold generating means 202 generates one or more distance thresholds. The velocity threshold generating means 204 generates one or more velocity thresholds. The safety level determining means 206 determines the exiting safety level and generates an exiting safety level signal.

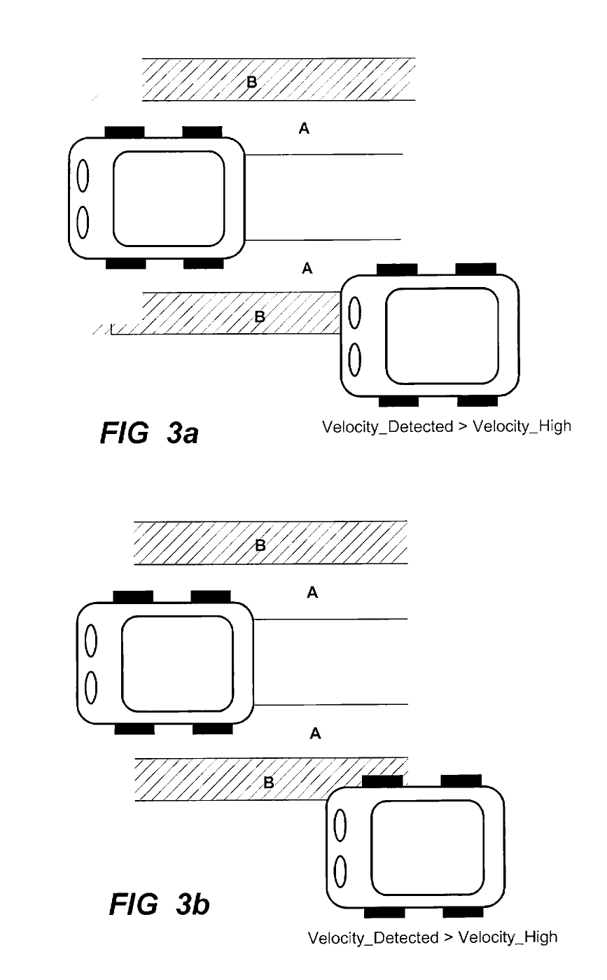

As shown in FIG. 3a and FIG. 3b, the logic of categorizing the exiting safety levels according to an embodiment is illustrated.

The distance threshold generating means 202 generates one or more distance thresholds signal indicative of one or more distance thresholds. As shown in FIGS. 3a and 3b, area A, which is close to the sides of the vehicle is regarded as an area that has a high possibility of accidents. Contour of area A may be used as a distance threshold Distance_Near. It should be noted that the distance threshold may be represented by a two-dimensional coordinate because the distance threshold represents an area. If the distance value of the relative position of the moving object is smaller than Distance_Near, it means that the moving object has entered area A. Area B is outside of area A, area B is regarded as an area that is possible to have accidents. Contour of area B may be used as a distance threshold Distance_Normal. This distance threshold may also be represented by a two-dimensional coordinate. If the distance value of the relative position of the moving object is between Distance_Near and Distance_Normal, it means that the moving object has entered area B. Areas outside of area B are regarded as safe areas, moving objects within the safe areas will not affect the exit of the passengers.

Not every moving object within area A or area B has a high risk. For example, a pedestrian who walks slowly has a risk much lower than a car which moves in a high speed. Therefore, the velocity threshold generating means 204 will evaluate the velocity of the moving object. A velocity threshold, Velocity_High may be set to represent a high moving velocity. The Velocity_High may usually be set at an average driving speed of cars, such as 40 km/h. If the moving velocity of the moving object is higher than Velocity_High, it is inferred that the moving object may be a vehicle. Another velocity threshold, Velocity_Low may be set to represent a low moving velocity. The Velocity_Low may usually be set at an average driving speed of bicycles, such as 10 km/h. If the moving velocity of the moving object is between Velocity_High and Velocity_Low, it is inferred that the moving object may be a bicycle. If the moving velocity of the moving object is lower than Velocity_Low, it is inferred that the moving object may be a pedestrian.

The safety level determining means 206 categorizes the exiting safety level to be: high danger (exiting the vehicle or opening the door is forbidden under high danger), medium danger (pay attention to the circumstance around the vehicle under medium danger), and low danger (opening the door and exiting the vehicle is allowed under low danger). The safety level determining means 206 also outputs a corresponding exiting safety level signal.

The logic of categorizing the exiting safety levels according to an embodiment is described here below, accompanying FIG. 3a, 3b and the distance thresholds Distance_Near and Distance_Normal, the velocity thresholds Velocity_High and Velocity_Low defined above.

If a detected distance value of the moving object Distance_Detected is smaller than Distance_Near, that is, Distance_Detected <Distance_Near, it means that the moving object has already within area A and has a high possibility of accidents. And, if a detected velocity value of the moving object Velocity_Detected is higher than Velocity_High, that is, Velocity_Detected >Velocity_High, it means that the moving object may be a vehicle with a high speed. As a result, it may be inferred that a vehicle with a high speed is closing from behind and is at an approximate position. The exiting safety level shall be determined as high danger, the safety level determining means 206 generates a corresponding high danger signal. An example of high danger is shown in FIG. 3a.

If a detected distance value of the moving object Distance_Detected is between Distance_Near and Distance_Normal, that is, Distance_Near <Distance_Detected <Distance_Normal, it means that the moving object is within area B and is possible to have accidents. And, if a detected velocity value of the moving object Velocity_Detected is higher than Velocity_High, that is, Velocity_Detected>Velocity_High, it means that the moving object may be a vehicle with a high speed. As a result, it may be inferred that a vehicle with a high speed is closing from behind and is at a position with a medium distance. The exiting safety level shall be determined as medium danger, the safety level determining means 206 generates a corresponding medium danger signal. An example of high danger is shown in FIG. 3b.

According to this logic of categorizing the exiting safety levels,

The level of high danger includes the following conditions:

Distance_Detected<Distance_Near and Velocity_Detected>Velocity_High, indicative of a vehicle with a high speed is closing within area A.

The level of medium danger includes the following conditions:

1) Distance_Detected<Distance_Near and Velocity_Low<Velocity_Detected <Velocity_High, indicative of a bicycle with a medium speed is closing within area A.

2) Distance_Near<Distance_Detected <Distance_Normal and Velocity_Detected>Velocity_High, indicative of a vehicle with a high speed is closing within area B.

The level of low danger includes the following conditions:

1) Distance_Detected<Distance_Near and Velocity_Detected<Velocity_Low, indicative of a pedestrian with area A, the pedestrian is moving slowly enough and there is no risk to open the door and exit the vehicle.

2) Distance_Near<Distance_Detected<Distance_Normal and Velocity_Detected<Velocity_High, indicative of a bicycle or a pedestrian within area B, a moving object with a relatively slow velocity in a relatively far area shall be safe.

3) Distance_Detected>Distance_Normal, indicative of a moving object that is far enough and there is no risk to open the door and exit the vehicle.

The safety controlling means 108 is configured to obtain the exiting safety level signal from the safety analyzing means 106 and output a control instruction corresponding to the exiting safety level.

According to an embodiment, the safety controlling means 108 outputs the following control instructions in response to the high danger level, medium danger level and low danger level:

Under high danger level, it means that to open the door and exit the vehicle is very dangerous, the safety controlling means 108 outputs a locking instruction to lock the door of the vehicle. The safety controlling means 108 is connected to a door locker controller of the vehicle.

Under medium danger level, it means that to open the door and exit the vehicle is allowed, but the circumstance around the vehicle shall be observed before that. The safety controlling means 108 outputs a lighting instruction to control the lights of the vehicle, the safety controlling means 108 is connected to a light controller of the vehicle. Under medium danger level, lights inside the vehicle are controlled so as to caution the passengers within the vehicle, and lights outside the vehicle are also controlled to caution the moving object which is approaching the vehicle that the doors are to be opened.

Under low danger level, no action is taken by the safety controlling means 108 since the moving object has no risk to the action of opening the door and exiting the vehicle.

According to an embodiment, the safety detection apparatus is automatically enabled, the safety detection apparatus is connected to a velocity detector. When the velocity detector detects that the velocity of the vehicle is lower that a predetermined value, such as 15 km/h, it is inferred that the vehicle is going to be stopped, than the safety detection apparatus is automatically enabled to detect the circumstance.

The safety detection apparatus may observe the circumstance around the vehicle before a passenger exits the vehicle, the safety detection apparatus determines a safety level and take appropriate actions to as to reduce the possibility of accident.

The previous description of the disclosed embodiments is provided to enable any person skilled in the art to make or use the present invention. Various modifications to these embodiments will be readily apparent to those skilled in the art and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A safety detection apparatus for exiting a vehicle, comprising:
a circumstance detecting means, configured to detect a moving object signal, wherein the moving object is around the vehicle;
a parameter determining means, configured to generate a relative position signal and a relative velocity signal of the moving object to the vehicle based on the moving object signal detected by the circumstance detecting means;
a safety analyzing means, configured to obtain the relative position signal and the relative velocity signal of the moving object from the parameter determining means and generate an exiting safety level signal;
a safety controlling means, configured to obtain the exiting safety level signal from the safety analyzing means and output a control instruction corresponding to the exiting safety level.

2. The apparatus of claim 1, wherein the circumstance detecting means comprises an infrared detector, a radar detector, or a video monitor.

3. The apparatus of claim 1, wherein the circumstance safety analyzing means comprises:
a distance threshold generating means, configured to generate one or more distance thresholds;
a velocity threshold generating means, configured to generate one or more velocity thresholds;
a safety level determining means, configured to generate an exiting safety level signal based on the relative position signal and the relative velocity signal of the moving object obtained by the parameter determining means, the distance threshold generated by the distance threshold generating means, and the velocity threshold generated by the velocity threshold generating means.

4. The apparatus of claim 1, wherein the safety controlling means is connected to a door locker controller of the vehicle, the safety controlling means output a locking instruction to lock the door of the vehicle.

5. The apparatus of claim 1, wherein the safety controlling means is connected to a light controller of the vehicle, the safety controlling means output a lighting instruction to control the lights of the vehicle.

6. The apparatus of claim 5, wherein the safety controlling means controls lights inside the vehicle through the light controller of the vehicle.

7. The apparatus of claim 5, wherein the safety controlling means controls lights outside the vehicle through the light controller of the vehicle.

8. The apparatus of claim 1, wherein the safety controlling means is connected to velocity detector, the apparatus is automatically enabled when the velocity detector detects that the velocity of the vehicle is lower that a predetermined value.

9. A safety detection apparatus for controlling occupant egress from a vehicle, said detection apparatus comprising:
an object detection device configured to sense moving objects external to said vehicle, and to generate input signals as a function of the relative velocity between the vehicle and each detected object, and as a function of the relative displacement between the vehicle and each detected object;
a parameter controller operative to receive said input signals and to generate a relative position signal and a relative velocity signal corresponding to at least one detected object;
a safety analyzer including a distance threshold generator and a velocity threshold generator, said safety analyzer operative to receive the relative position signal and the relative velocity signal of the selected moving object from the parameter controller, to compare said relative position signal with at least one distance threshold and/or compare said relative velocity signal with at least one velocity threshold, and to generate an exiting safety level signal as a function thereof;
a safety controller operative to receive the exiting safety level signal from the safety analyzer and output a control instruction corresponding to the exiting safety level, selected from a plurality of predetermined instructions ranked by levels of prospective occupant danger incurred upon hypothetical egress from the vehicle.
